(19) United States
(12) Patent Application Publication
(10) Pub. No.: US 2026/0357142 A1
(43) Pub. Date: Nov. 12, 2026

(54) PROCESS FOR PRODUCING MIDDLE DISTILLATES BY CO-PROCESSING OF MINERAL FEEDSTOCK WITH A RENEWABLE FEEDSTOCK COMPRISING A SERIES OF CATALYSTS, INCLUDING A BETA ZEOLITE-BASED CATALYST

(71) Applicant: IFP Energies Nouvelles, Rueil-Malmaison (FR)

(72) Inventors: Minh Tuan NGUYEN, Rueil-Malmaison Cedex (FR); Bertrand GUICHARD, Rueil-Malmaison Cedex (FR); Antoine DAUDIN, Rueil-Malmaison Cedex (FR); Benoit CELSE, Rueil-Malmaison Cedex (FR)

(73) Assignee: IFP Energies Nouvelles, Rueil-Malmaison (FR)

(21) Appl. No.: 19/131,344

(22) PCT Filed: Nov. 13, 2023
(86) PCT No.: PCT/EP2023/081567

§ 371 Date: May 20, 2025

(30) Foreign Application Priority Data
Nov. 21, 2022 (FR) 2212075

(51) Int. Cl. C10G 47/20; B01D 3/10; B01J 27/19; B01J 29/08; B01J 29/16; B01J 29/70; B01J 29/78; B01J 29/80

(52) U.S. Cl. CPC C10G 47/20; B01D 3/10; B01J 27/19; B01J 29/084; B01J 29/166; B01J 29/7007; B01J 29/7815; B01J 29/80; C10G 2300/1003; C10G 2300/1014; C10G 2300/1018

(57) ABSTRACT

A process is provided for producing middle distillates from at least one fossil hydrocarbon feedstock as a mixture with at least one renewable feedstock. In the process, the feedstocks are hydrotreated in the presence of hydrogen and of at least one hydrotreatment catalyst. The hydrotreated feedstock is subjected to hydrocracking wherein the hydrotreated feedstock is contacted in a first catalytic zone with at least one first catalyst comprising at least one metal from group VIB and/or at least one metal from group VIII and a support comprising at least one zeolite and at least one binder, followed by contacting, in a second catalytic zone, all of the effluent, without an intermediate separation, with a second catalyst comprising at least one metal from group VIB and/or at least one metal from group VIII of and a support comprising at least one zeolite of BEA structure and at least one binder.

### TECHNICAL FIELD

The present invention relates to a process for producing middle distillates, comprising a hydrotreatment step and a hydrocracking step, said hydrocracking step being characterized in that it employs two catalysts in two separate hydrocracking zones operated in series. This process converts a set of hydrocarbon feedstocks into products of interest (naphtha, jet fuel, diesel). These hydrocarbon feedstocks for example contain aromatic and/or olefinic and/or naphthenic and/or paraffinic compounds including “fossil” feedstocks, such as vacuum distillates (VDs) cuts or vacuum gas oil (VGO) cuts resulting from the direct distillation of crude oil or from conversion units such as FCC, coking, H-Oil or visbreaking units, feedstocks resulting from the Fischer-Tropsch process, feedstocks resulting from the transformation of bituminous sands and shale oils, as a mixture with at least one renewable feedstock chosen from vegetable oils, algal oils, cooking oils and animal fats, which may be fresh or spent, alone or as a mixture, and feedstocks obtained from the reprocessing of biomass/plastics/tires/and household waste, alone or as mixtures. These feedstocks may possibly contain metals and/or nitrogen and/or oxygen and/or sulfur.

The objective of the process according to the invention is essentially that of producing a middle distillates cut, comprising a kerosene cut having initial and final boiling points within a range extending from 130 to 300 °C and a gas oil cut having initial and final boiling points within a range extending from 220 to 390 °C.

In particular, the present invention relates to a process for producing middle distillates from a hydrocarbon feedstock preferably of vacuum distillate type, as a mixture with at least one renewable feedstock chosen from vegetable oils, algal oils, cooking oils and animal fats, which may be fresh or spent, alone or as a mixture, and feedstocks obtained from the reprocessing of biomass/plastics/tires/and household waste, alone or as mixtures, said process comprising a hydrotreatment step and a hydrocracking step. The hydrocracking step is carried out in the presence of a sequence of 2 specific catalysts, employed in two separate catalytic zones, all of the effluent resulting from the first catalytic zone being sent directly into the second catalytic zone in contact with a second catalyst, without intermediate separation of the gas phase between the 2 catalytic zones of said second hydrocracking step.

In particular, the first catalyst employed in the first catalytic zone of the hydrocracking step comprises at least one metal from group VI and/or at least one metal from group VIII of the periodic table and a support comprising at least one large-pore zeolite (12MR), making it possible to quite considerably convert the hydrocarbon feedstock upstream of the second catalyst.

The second catalyst employed in the second catalytic zone of the hydrocracking step comprises, according to the invention, at least one metal from group VIB and/or at least one metal from group VIII of the periodic table and a support comprising at least one zeolite of BEA structural type.

### PRIOR ART

The process for producing middle distillates including a step of hydrocracking heavy petroleum cuts is a process that is now indispensable in refining and which makes it possible to produce, from surplus and not readily upgradable heavy feedstocks, lighter fractions, such as gasolines, jet fuels and gas oils, sought by refiners in order to adapt their production to demand conditions. Certain hydrocracking processes make it possible to also obtain a highly purified residue that may provide excellent bases for the production of oils. Compared to catalytic cracking (FCC), the advantage of catalytic hydrocracking is that of providing middle distillates of very good quality. Conversely, the gasoline produced has a much lower octane number than that obtained from catalytic cracking.

This process which draws its flexibility from three main elements which are: the operating conditions used, the types of catalysts employed and the fact that the hydrocracking of hydrocarbon feedstocks may be carried out in one step or in two steps. It is thus suitable for treating and converting any type of hydrocarbon feedstock, so long as the latter is compatible with injection in liquid form into catalytic reactors. In particular, it is capable of using, alone or as a mixture, feedstocks resulting from the distillation of a crude oil, but also vegetable oils, animal fats, for example.

It can be carried out in one step in one or more reactors in series in the presence of a single catalyst that not only hydrocracks the hydrocarbon feedstock into products with a lower boiling point, but also converts residual organic compounds comprising sulfur and nitrogen respectively into hydrogen sulfide and ammonia.

The hydrocracking catalysts used in the processes for producing middle distillates are referred to as bifunctional, i.e. combining an acid function with a hydrogenating-dehydrogenating function. The acid function is provided by oxides having surface areas that generally range from 150 to 1000 m²·g⁻¹, such as halogenated (in particular chlorinated or fluorinated) aluminas, combinations of boron and aluminum oxides, amorphous silica-aluminas and zeolites. The hydrogenating-dehydrogenating function is provided either by one or more metals from group VIB of the periodic table of the elements or by a combination of at least one metal from group VIB of the periodic table and at least one metal from group VIII.

The equilibrium between these two functions is one of the parameters governing the activity and the selectivity of the catalyst. A weak acid function and a strong hydrogenating-dehydrogenating function afford catalysts that are not very active, operating at a generally elevated temperature (greater than or equal to 390-400 °C), and at a low feed space velocity (the HSV expressed in volume of feedstock to be treated per unit of volume of catalyst and per hour is generally less than or equal to 2 h⁻¹), but which possess very good selectivity for middle distillates (jet fuels and gas oils). Conversely, a strong acid function and a weak hydrogenating-dehydrogenating function afford catalysts that are active but which have worse selectivities for middle distillates.

One type of conventional hydrocracking catalysts is based on moderately acidic amorphous oxides, such as for example silica-aluminas. These systems are used to produce good quality middle distillates and, possibly, oil bases. The drawback of these catalysts based on an amorphous support is their low activity.

Catalysts comprising for example zeolite Y or catalysts comprising for example a zeolite beta for their part exhibit a catalytic activity greater than that of silica-aluminas, but exhibit generally lower selectivities for middle distillates (jet fuels and gas oils).

In general, hydrocracking catalysts which contain only zeolite Y do not make it possible to obtain good cold properties of the gas oil cut (in terms of cloud point, pour point, cold filter plugging point of said cut), but also of the kerosene cut (in terms of crystal appearance point). These values are highly correlated with the higher-boiling-point linear paraffins present in these cuts. In order to meet the fuel specifications in terms of cold properties, this may require the refiner to lower the final boiling point of the cuts (to reduce the content of high-boiling-point paraffins) with the direct effect of a reduction in their yield in favour of heavy cuts that are not, or are less, upgradable.

The prior art mentions numerous studies for improving the selectivity of zeolitic catalysts for middle distillates in hydrocracking processes. The latter are composed of a hydrogenating-dehydrogenating phase based on transition metals, generally deposited on a support containing a zeolite, usually a zeolite USY. The hydrogenating-dehydrogenating phase is generally in the form of sulfide of transition metals.

For example, mention may be made of studies relating to the use of catalysts comprising a zeolite Y modified for example by dealumination by steaming or acid attack, the use of composite catalysts, or the use of small crystals of zeolites Y. Other patent applications such as patent U.S. Pat. No. 7,585,405 describe the use of a catalyst comprising a mixture of zeolites such as zeolites beta and USY for improving the performance of hydrocracking catalysts. Fine adjustment of the USY/beta mass ratio is necessary in order to make it possible to maximize the yield of middle distillates, with it also being necessary here to precisely select a zeolite USY with in particular a lattice parameter of between 24.37 and 24.44 Å. There is no mention of the change in the relative yields of gas oil and kerosene cuts.

Patent application WO08085517, in contrast, provides for the use of a single zeolite source for the formulation of the catalyst. The zeolite beta introduced has an SAR of less than 30, and it is taught that it is preferable that it undergoes little post-treatment after removal of the structuring agent used in the manufacture. Gains in middle distillates yields of the order of 2 to 3 points are demonstrated, compared with other catalytic formulations with zeolite beta that have undergone various heat treatments in the presence of steam (steaming), without specifying the respective yields of gas oil or kerosene cuts.

As a general rule, when the catalyst or the operating conditions of the hydrocracking process are modified, various technical solutions have been proposed which lead to an improvement in the yield of middle distillates, but this increase is generally borne by a gain in the yield of the gas oil cut, the gain in kerosene cut remaining low or even zero.

One alternative could consist, as described in patent U.S. Pat. No. 7,749,373, in using a first hydrocracking catalyst containing an acid function followed by a second catalyst containing a zeolite beta, without any intermediate separation of the gas or liquid products between the two catalytic zones. Preferably, in this case, the second catalyst comprises a zeolite beta having an SAR of greater than 25 and very preferably of greater than 250. The examples demonstrate that, after a prior hydrotreatment of a feedstock of vacuum distillate type, the sequence of, firstly, 75% by volume of a catalyst comprising 10% by weight in its support of a zeolite Y with an SAR equal to 30 and having a lattice parameter equal to 24.29 Å, and then a catalyst comprising 3% beta in its support, said beta having an SAR of 300, makes it possible to reduce the operating temperature by 4 °C, to achieve 87% target conversion, compared with a loading carried out with only the catalyst supported on the zeolite Y. A gain of 3.5% by weight is then also observed in the middle distillates yield, which is entirely borne by the increase in yield in the gas oil cut, the yield of kerosene not changing (nor its cold properties, either). In other words, the process employing said catalyst sequence makes it possible to improve the yield of the gas oil cut as well as improve the cold properties of said gas oil cut in terms of pour point, but said process does not enable any improvement in the yield of the kerosene cut obtained. The same goes for the cold properties of the kerosene cut, which are identical to that obtained with respect to a process using only a catalyst comprising a zeolite Y, for the same amount of catalyst used.

In order to specifically maximize the production of middle distillates and reduce the carbon footprint of the refining processes, it may also prove advantageous to work with renewable feedstocks, in addition to fossil feedstocks, which may lead to a reduction in the carbon footprint. Among the renewable feedstocks, mention may for example be made of vegetable oils, animal fats or spent cooking oils which, after hydrotreatment, generally lead to long linear paraffins comprising mainly nC₁₅ to nC₁₈ hydrocarbons with boiling points compatible with the fossil gas oil cut. Nevertheless, these linear paraffins impart degraded cold properties on the gas oil, which entails the need to isomerize these compounds in order to achieve the required fuel specifications. Another advantageous solution is also to convert these linear paraffins by selective hydrocracking for direct incorporation into the kerosene cut. This also makes it possible to introduce renewable carbon into this fossil cut. The production of biokerosene, also known as SAF (“Sustainable Aviation Fuel”), is particularly sought after in order to decarbonize the aviation sector, both civil and military.

Thus, in the context of reducing greenhouse gas emissions, refiners must increase the proportion of components of biological origin in fuels. Public authorities are aiming to promote the use of biofuels in transport, not just in road transport (diesel and petrol engines) but also in air transport. For example, the Roadmap of Ancre (the French National Alliance for the Coordination of Energy Research), published in June 2018, assesses the French potential of the sectors for the production of biofuels for aviation, taking into account the maturity and time for development of these industrial sectors. The deployment trajectory that follows therefore reflects the French ambition of incorporating aviation biofuels in France by 5% by 2030. In addition, the French National Low Carbon Strategy (SNBC), revised in 2018, sets for air transport a long-term guidance by 2050 targeting a 50% substitution of conventional fuel of fossil origin by biofuels. The production of biofuel has therefore been promoted in recent years and will continue to be stepped up to a significant extent in the coming years.

Numerous patent applications describe the co-treatment of renewable feedstocks with a fossil feedstock for the purpose of producing either a gas oil cut or a kerosene cut, or both, these cuts incorporating a portion of biogenic carbon.

For example, the incorporation of renewable lipid feedstocks containing triglycerides with gas oil cuts, which are petroleum fossil feedstocks, in the process of hydrotreatment with co-treatment, has been described in documents FR 2 949 475, EP 1 693 432 and EP 2 046 917 B1. This incorporation makes it possible to produce a renewable gas oil cut and to integrate it directly into the diesel pool obtained from fossil resources without investing in a dedicated hydrotreatment unit. The advantages of co-treating a triglyceride-containing feedstock with a fossil petroleum cut compared to the treatment of a pure lipid feedstock are well detailed in document FR 2 949 475 A1, such as for example:
Limitation of the polymerizations associated with the thermal instability of the renewable feedstocks,
Reduction, by the dilution effect, of the contents of sulfur, nitrogen and aromatics,
Limitation of the exotherms associated with the hydrotreatment of the biological feedstocks,
Reduction of the content of CO and CO₂ in the gaseous effluent: limitation of the inhibitory effect on the catalytic activity by the CO and limitation of the risks of corrosion in the presence of water and CO₂,
Increase in the solubility of hydrogen in the mixture to be treated.

The hydrotreatment process makes it possible to essentially produce a renewable gas oil fraction according to the incorporation rate at the inlet of the process, i.e. cuts with an initial boiling point of 250 °C or 280 °C and a final boiling point ranging up to 340 °C, or to 370 °C.

In addition to renewable gas oil, the hydrocracking process makes it possible to produce lighter biogenic products such as biokerosene and bionaphtha.

The production of biokerosene (or SAF) is attracting increasing attention compared to the production of renewable diesel within the context of the energy transition. On the other hand, the upgrading of biological resources to bionaphtha for petrochemicals industry (with a view to the production of olefins, BTX aromatics, polymers and cosmetic products, etc.) is also of increasing interest. Refiners are therefore increasingly interested in technical solutions that make possible the incorporation of biokerosene into fossil kerosene and the production of bionaphtha for the petrochemicals industry.

The invention WO 2009/148909 A2 describes that pure feedstocks containing triglycerides such as palm oil and animal fat can be converted over the sequence of the steps of hydrotreatment (over a sulfided NiMo catalyst supported on alumina) and hydrocracking (over a Pt-PD catalyst supported on amorphous silica-alumina) for the production of bionaphtha, for yields up to 28% by weight.

Patent application WO 2011/012439 A1 describes that lipid feedstocks can be converted into n-paraffins and propane by hydrodeoxygenation and decarbonylation over a conventional hydrotreatment catalyst. These n-paraffins with the fossil naphtha are then mixed and injected into the steam cracking unit for the production of olefins, diolefins and aromatics.

Document EP 2 143 777 A1 describes a process for hydrocracking a feedstock consisting of a mixture of a vacuum distillate with vegetable or animal fat feedstocks, with a sequence of hydrotreatment catalyst (NiMo/Al₂O₃ type), followed by a hydrocracking catalyst (NiMo/zeolite type) and then by a post-treatment catalyst (hydrodesulfurization type) making it possible to obtain a gas oil with a very low content of sulfur. The incorporation of a biological feedstock with the vacuum distillate, according to this invention, makes it possible to significantly increase the yield of gas oil cut, but this unfortunately results in a decrease in the yield of kerosene. For example, this document notes an increase of 6% in the yield of the gas oil cut but a decrease of more than 3% in the kerosene cut with the incorporation of 10% by weight of soybean oil as a mixture with a vacuum distillate. On the other hand, the gas oil cut obtained has degraded cold properties: cloud point that is 3 °C higher than fossil gas oil obtained without incorporation of soybean oil.

It is well known that, under the hydrotreatment operating conditions, the n-paraffins resulting from the lipid feedstock are hardly converted. At the end of said process, the products predominantly found are therefore normal-paraffins having a number of carbon atoms that is identical to or lower by just one unit compared to the starting carboxylic acid chain present in the triglycerides. Currently, the most abundant lipid feedstocks for biofuel production are rapeseed oil, soybean oil, palm oil, and derivatives thereof, and to a lesser extent spent cooking oils and animal fats. These renewable feedstocks mainly contain triglycerides with fatty chains containing 16 and 18 carbon atoms. Thus, the major products obtained after hydrotreatment will be normal-paraffins containing predominantly 15 to 18 carbon atoms. Consequently, the products of these biological feedstocks will be found predominantly in the gas oil cut, that is to say in the cut having initial and final boiling points in a range extending from 220 to 390 °C.

In this case, obtaining a biokerosene cut requires an additional selective hydrocracking step.

U.S. Pat. No. 8,039,682 describes a process for producing kerosene from a renewable feedstock, optionally with co-processing with a fossil feedstock, comprising a step of hydrotreatment, hydrodeoxygenation, isomerization and selective hydrocracking in the presence of a multifunctional catalyst or of a series of catalysts, a step of gas/liquid separation of the effluent obtained followed by a step of separation of the paraffinic effluent to produce a jet fuel effluent and a light naphtha effluent and an effluent that is heavier than the jet fuel, and then recycling of the effluent that is heavier than the jet fuel into the reaction zone with a recycle/feedstock ratio by volume of between 0.1 and 8.

Lastly, were a catalytic system available that was capable of hydroisomerizing and/or selectively hydrocracking the compounds of a gas oil hydrocarbon cut to the lighter kerosene cut, it would then be possible to produce large amounts of (bio) kerosene from a very wide range of feedstocks without modifying the existing processes. However, to the applicant's knowledge, and as highlighted by all of the examples previously reported, existing knowledge does not allow this type of conversion to be carried out.

The applicant has discovered that the use of a process for producing middle distillates that includes a hydrocracking step using a fossil hydrocarbon feedstock as a mixture with a renewable feedstock that has previously been hydrotreated, of a sequence of specific catalysts without modifying the process for hydrocracking a fossil feedstock, makes possible production with a high yield of kerosene and gas oil cut including a high degree of incorporation of biogenic carbon.

In particular, the use of a sequence, in a first catalytic zone, of a first hydrocracking catalyst comprising a large-pore zeolite, preferably having at least one opening of at least 12MR, and metals from group VIB and from group VIII according to the periodic table, and then, without any separation being performed between the first and second catalytic zones, the use of a second catalyst, in a second catalytic zone, comprising at least one metal from group VIB and/or at least one metal from group VIII of the periodic table and a support comprising at least one zeolite of BEA structure code, makes it possible:
to improve the selectivity for the kerosene cut while simultaneously resulting in cold properties of said gas oil and kerosene cuts that are improved compared to the use of any other catalyst or sequence of catalysts known to a person skilled in the art, compared to that obtained in a hydrocracking process using solely said first catalyst if the latter was used over the entirety of the hydrocracking step, i.e. in 100% of the volume dedicated to the hydrocracking step.

### SUMMARY OF THE INVENTION

A subject of the present invention is a process for producing middle distillates from at least one fossil hydrocarbon feedstock of which at least 50% by weight of the compounds have an initial boiling point of greater than 250 °C and a final boiling point of less than 800 °C, said fossil hydrocarbon feedstock being co-treated as a mixture with at least one renewable feedstock chosen from vegetable oils, algal oils, cooking oils and animal fats, which may be fresh or spent, alone or as a mixture, and feedstocks obtained from the reprocessing of biomass/plastics/tires/and household waste, alone or as mixtures, said process comprising a step of hydrotreating said feedstock mixture in the presence of hydrogen and of at least one hydrotreatment catalyst and a step of hydrocracking at least some and preferably all of the hydrotreated feedstock, the hydrocracking step being carried out at a temperature of between 200 °C and 480 °C, at a total pressure of between 1 MPa and 25 MPa with a ratio of volume of hydrogen to volume of hydrocarbon feedstock of between 80 and 5000 liters per liter and at an hourly space velocity (HSV), defined by the ratio of the flow rate by volume of liquid hydrocarbon feedstock to the volume of catalyst charged into the reactor, of between 0.1 and 50 h⁻¹, the step of hydrocracking the hydrotreated feedstock comprising at least:
a) a step of contacting at least some and preferably all of said hydrotreated feedstock in a first catalytic zone with at least one first catalyst comprising at least one metal from group VIB and/or at least one metal from group VIII of the periodic table and a support comprising at least one zeolite having at least one series of channels the opening of which is defined by a ring of 12 oxygen atoms (12MR), and at least one binder,
b) followed by contacting, in a second catalytic zone, all of the effluent resulting from step a), without an intermediate separation step between said first catalytic zone and said second catalytic zone, with a second catalyst comprising at least one metal from group VIB and/or at least one metal from group VIII of the periodic table and a support comprising at least one zeolite of BEA structure code and at least one binder.

An advantage of the present invention is that of providing a process for producing middle distillates employing in the hydrocracking step a sequence of specific catalysts making it possible to obtain a high yield of kerosene, and also cold properties of the kerosene and gas oil cuts which are improved compared with those obtained in the prior art.

In particular, an advantage of the present invention is that of providing a hydrocracking process making it possible to improve mainly the selectivity for kerosene cuts, while also making it possible to obtain cold properties of the kerosene and gas oil cuts which are improved compared with the use of catalysts or of the sequence of catalysts of the prior art.

For the purposes of the present invention, the various embodiments presented may be used alone or in combination with each other, without any limit to the combinations.

For the purposes of the present invention, the various ranges of parameters for a given step, such as the pressure ranges and the temperature ranges, may be used alone or in combination. For example, for the purposes of the present invention, a preferred range of pressure values may be combined with a more preferred range of temperature values.

In the text which follows, groups of chemical elements are given according to the CAS classification (CRC Handbook of Chemistry and Physics, published by CRC Press, editor in chief D. R. Lide, 81st edition, 2000-2001). For example, group VIII according to the CAS classification corresponds to the metals from columns 8, 9 and 10 according to the new IUPAC classification, and group VIB corresponds to the metals from column 6.

In the text which follows, the expressions “of between . . . and . . . ” and “between . . . and . . . ” are equivalent and mean that the limiting values of the interval are included in the described range of values. If such were not the case and if the limiting values were not included in the range described, such a clarification will be provided by the present invention.

In the present description, the expression “greater than . . . ” is understood as strictly greater, and symbolized by the sign “>”, and the expression “less than” as strictly less, and symbolized by the sign “<”.

In the present description, the overall SiO2/Al2O3 molar ratio of a zeolite is also referred to as the SAR or silica-alumina ratio. The SiO2/Al2O3 molar ratio is measured by X-ray fluorescence.

### DESCRIPTION OF THE EMBODIMENTS

The invention relates to a process for producing middle distillates from at least one fossil hydrocarbon feedstock of which at least 50% by weight of the compounds have an initial boiling point of greater than 250 °C and a final boiling point of less than 800 °C, as a mixture with at least one renewable feedstock chosen from vegetable oils, algal oils and animal fats, which may be fresh or spent, alone or as a mixture, and feedstocks obtained from the reprocessing of plastics/tires/and household waste, alone or as mixtures.

### Feedstocks

Very varied hydrocarbon feedstocks can be treated by the hydrocracking processes according to the invention. The fossil hydrocarbon feedstock used in the hydrocracking process according to the invention is a hydrocarbon feedstock of which at least 50% by weight of the compounds have an initial boiling point of greater than 250 °C and a final boiling point of less than 800 °C, preferably of which at least 60% by weight, preferably of which at least 75% by weight and more preferably of which at least 80% by weight of the compounds have an initial boiling point of greater than 250 °C and a final boiling point of less than 800 °C.

The fossil hydrocarbon feedstock is advantageously chosen from gas oils resulting from a catalytic cracking unit or LCOs (light cycle oils), atmospheric distillates, vacuum distillates resulting from the direct distillation of crude oil or from conversion units, such as FCC, coking, H-Oil or visbreaking units, feedstocks originating from units for the extraction of aromatics from lubricating oil bases or resulting from the solvent dewaxing of lubricating oil bases, distillates originating from processes for the fixed-bed or ebullated-bed desulfurization or hydroconversion of ATRs (atmospheric residues) and/or VRs (vacuum residues) and/or deasphalted oils. The above list is not limiting. Said feedstocks preferably have a boiling point T5 of greater than 200 °C, preferably of greater than 340 °C, that is to say that 95% by weight of the compounds present in the feedstock have a boiling point of greater than 250 °C, and preferably of greater than 340 °C.

According to the invention, the fossil hydrocarbon feedstock is treated in the process according to the invention as a mixture with at least one renewable feedstock chosen from vegetable oils, cooking oils, algal oils and animal fats, which may be fresh or spent, alone or as a mixture, and feedstocks obtained from the reprocessing of biomass/plastics/tires/and household waste, alone or as mixtures.

The vegetable oils may advantageously be crude or wholly or partially refined and obtained from the following plants: rapeseed, sunflower, soybean, palm, palm kernel, olive, coconut, jatropha, this list not being limiting. Algal oils or fish oils are also relevant. The animal fats are advantageously chosen from lard or fats composed of residues from the food industry or resulting from the catering industries.

These feedstocks essentially contain chemical structures of triglyceride type that a person skilled in the art also knows under the name fatty acid triester and also as free fatty acids. A fatty acid triester is thus composed of three fatty acid chains. These fatty acid chains in triester form or in free fatty acid form have a number of unsaturations per chain, also referred to as the number of carbon-carbon double bonds per chain, generally of between 0 and 3, but which may be higher in particular for oils derived from algae which generally have from 5 to 6 unsaturations per chain.

More generally, the process according to the invention is capable of treating the abovementioned feedstocks alone or as a mixture, whatever the proportions.

Preferably, the content of renewable feedstock in the feedstock mixture is between 0.5% and 40% by weight relative to the total mass of the feedstock treated in the process according to the invention, and preferably between 1% and 35% by weight, preferably between 2% and 30% by weight and more preferably between 5% and 25% by weight.

These feedstocks may possibly contain metals and/or nitrogen and/or oxygen and/or sulfur. If appropriate, the process according to the invention may optionally advantageously comprise a liquid/gas separation step between the step of hydrotreating said feedstock and the hydrocracking step.

The nitrogen content of the feedstocks treated in the processes according to the invention is generally greater than 500 ppm by weight, preferably between 500 and 10 000 ppm by weight, more preferably between 700 and 4000 ppm by weight and more preferably still between 1000 and 4000 ppm by weight. The sulfur content of the feedstocks treated in the processes according to the invention is advantageously between 0.01% and 5% by weight, preferably between 0.2% and 4% by weight and more preferably still between 0.5% and 3% by weight.

The feedstock may optionally contain metals. The combined nickel and vanadium content of the feedstocks treated in the processes according to the invention is preferably less than ppm, preferably less than 3 ppm and more preferably still less than 1 ppm by weight.

The feedstock may optionally contain asphaltenes. The asphaltene content is generally less than 3000 ppm by weight, preferably less than 1000 ppm by weight and more preferably still less than 300 ppm by weight.

Because of the presence of renewable feedstocks derived from biomass, said feedstock treated in the process according to the invention may also contain oxygenated compounds. The content thereof is highly variable depending on the feedstock that is to be converted in the process according to the invention. It is generally less than 50% by weight, and preferably is less than 15%, very preferably less than 5% by weight, more preferably still less than 2% by weight.

### Embodiment

In accordance with the invention, the process comprises a step of hydrotreatment of said feedstocks, in the presence of hydrogen and of at least one hydrotreatment catalyst, said hydrotreatment step being performed preferably at a temperature of between 200 and 450 °C, under a pressure of between 2 and 25 MPa, at a space velocity of between 0.1 and 6 h⁻¹ and with an amount of hydrogen introduced such that the liter of hydrogen/liter of hydrocarbon ratio by volume is between 100 and 5000 NI/I.

The operating conditions such as temperature, pressure, hydrogen recycle ratio and hourly space velocity will be highly variable depending on the nature of the feedstock, on the quality of the products desired and on the facilities available to the refiner.

Preferably, the hydrotreatment step according to the invention is performed at a temperature of between 250 and 450 °C, very preferably between 300 and 430 °C, under a pressure of between 5 and 20 MPa, at a space velocity of between 0.2 and 5 h⁻¹ and with an amount of hydrogen introduced such that the liter of hydrogen/liter of hydrocarbon ratio by volume is between 300 and 3000 NI/I.

Conventional hydrotreatment catalysts may advantageously be used in supported or unsupported form, preferably containing at least one amorphous support and at least one hydrogenating-dehydrogenating element chosen from at least one non-noble element from groups VIB and VIII, and usually at least one element from group VIB (from among molybdenum or tungsten taken alone or as a mixture) and at least one non-noble element of group VIII (from among nickel or cobalt taken alone or as a mixture).

Preferably, the amorphous support is alumina or silica-alumina.

Preferred catalysts are chosen from the catalysts NiMo, NiW, NiMoW or CoMo supported on alumina and NiMo, NiW or NiMoW supported on silica-alumina.

The effluent resulting from the hydrotreatment step and a portion and preferably all of which enters hydrocracking step a) generally comprises a nitrogen content preferably of less than 300 ppm by weight, of less than 200 ppm by weight, preferably of less than 100 ppm by weight and preferably of less than 50 ppm by weight.

The process according to the invention may advantageously comprise a separation step between the hydrotreatment step and the hydrocracking step.

In one embodiment, the process according to the invention does not comprise a separation step between the hydrotreatment step and the hydrocracking step.

In accordance with the invention, the process comprises a step of hydrocracking at least some and preferably all of the hydrotreated feedstock, the hydrocracking step being carried out at a temperature of between 200 °C and 480 °C, at a total pressure of between 1 MPa and 25 MPa, with a ratio of volume of hydrogen per volume of hydrocarbon feedstock of between 80 and 5000 liters per liter and at an hourly space velocity (HSV) defined by the ratio of the volume flow rate of liquid hydrocarbon feedstock per the volume of catalyst charged into the reactor of between 0.1 and 50 h⁻¹.

Preferably, the hydrocracking step of the process according to the invention is carried out in the presence of hydrogen, of between 250 and 480 °C, preferably between 320 and 450 °C, very preferably between 330 and 435 °C, under a pressure of between 2 and 25 MPa, preferably between 3 and 20 MPa, at a space velocity of between 0.1 and 20 h⁻¹, preferably 0.1 and 6 h⁻¹, with preference between 0.2 and 3 h⁻¹, and the amount of hydrogen introduced is such that the liter of hydrogen/liter of hydrocarbon ratio by volume is between 100 and 3000 I/I.

These operating conditions used in the processes according to the invention generally make it possible to obtain conversions per pass, into products having boiling points of less than 340 °C and better still of less than 370 °C, of greater than 15% by weight and more preferably still of between 20% and 95% by weight.

In addition, the kerosene cut produced by the process according to the invention has a crystal disappearance point of less than −20 °C, preferably of less than −30 °C and more preferably still of less than −47 °C. The gas oil cut produced by the process has a cloud point of less than °C, preferably of less than 5 °C and very preferably of less than −5 °C.

In accordance with the invention, the step of hydrocracking at least some and preferably all of the hydrotreated feedstock comprises at least:
a) a step of contacting said hydrotreated feedstock in a first catalytic zone with at least one first catalyst comprising at least one metal from group VIB and/or at least one metal from group VIII of the periodic table and a support comprising at least one zeolite having at least one series of channels the opening of which is defined by a ring of 12 oxygen atoms (12MR), and at least one binder,
b) followed by contacting, in a second catalytic zone, all of the effluent resulting from step a), without an intermediate separation step between said first and second catalytic zones, with a second catalyst comprising at least one metal from group VIB and/or at least one metal from group VIII of the periodic table and a support comprising at least one zeolite of BEA structure code and at least one binder.

Preferably, the first catalyst used in the first catalytic zone of hydrocracking step a) comprising at least one metal from group VIB and at least one metal from group VIII of the periodic table, taken alone or as a mixture, is preferably a sulfide-phase catalyst.

Preferably, the metals from group VIB of the periodic table are chosen from the group formed by tungsten and molybdenum, taken alone or as a mixture. According to a preferred embodiment, the metal from group VIB is molybdenum. According to another preferred embodiment, the metal from group VIB is tungsten.

Preferably, the non-noble metals from group VIII of the periodic table are chosen from the group formed by cobalt and nickel, taken alone or as a mixture. According to a preferred embodiment, the non-noble metal from group VIII is cobalt. According to another preferred embodiment, the non-noble metal from group VIII is nickel.

Preferably, said catalyst comprises at least one metal from group VIB in combination with at least one non-noble metal from group VIII, the non-noble metals from group VIII being chosen from the group formed by cobalt and nickel, taken alone or as a mixture, and the metals from group VIB being chosen from the group formed by tungsten and molybdenum, taken alone or as a mixture.

In one embodiment, the following combinations of metals are used: nickel-molybdenum, cobalt-molybdenum, nickel-tungsten, cobalt-tungsten, and more advantageously still nickel-molybdenum and nickel-tungsten.

In the case where the catalyst comprises at least one metal from group VIB in combination with at least one non-noble metal from group VIII, the content of metal from group VIB, as oxide equivalent, is advantageously between 5% and 40% by weight relative to the total mass of said catalyst, preferably between 10% and 35% by weight and very preferably between 15% and 30% by weight, and the content of non-noble metal from group VIII, as oxide equivalent, is advantageously between 0.5% and 10% by weight relative to the total mass of said catalyst, preferably between 1% and 8% by weight and very preferably between 1.5% and 6% by weight.

In the case where the catalyst comprises at least one metal from group VIB in combination with at least one non-noble metal from group VIII, said catalyst is a sulfided catalyst.

It is also possible to use combinations of three metals, for example nickel-cobalt-molybdenum, nickel-molybdenum-tungsten, nickel-cobalt-tungsten.

In one embodiment, the following combinations of metals are used: nickel-niobium-molybdenum, cobalt-niobium-molybdenum, nickel-niobium-tungsten, cobalt-niobium-tungsten, the preferred combinations being: nickel-niobium-molybdenum, cobalt-niobium-molybdenum. It is also possible to use combinations of four metals, for example nickel-cobalt-niobium-molybdenum.

The catalyst may advantageously also comprise at least one doping element chosen from the group consisting of boron and phosphorus, and preferably phosphorus.

The first catalyst may also advantageously comprise:
from 0.1% to 15% by weight of oxide, preferably from 0.1% to 10% by weight, relative to the total mass of the catalyst, of at least one doping element chosen from the group consisting of boron and phosphorus, and preferably phosphorus,
from 0% to 60% by weight, preferably from 0.1% to 50% by weight, and more preferably still from 0.1% to 40% by weight of oxide, relative to the total mass of the catalyst, of at least one element chosen from group VB and preferably niobium,
from 0% to 20% by weight, preferably from 0.1% to 15% by weight and more preferably still from 0.1% to 10% by weight of oxide, relative to the total mass of the catalyst, of at least one element chosen from group VIIA, and preferably fluorine.

In accordance with the invention, the support of the first catalyst used in the first catalytic zone of hydrocracking step a) according to the invention comprises at least one zeolite having at least one series of channels the opening of which is defined by a ring of 12 oxygen atoms (12MR), and at least one binder.

The binder used in the support of the first catalyst, also referred to as porous mineral matrix, advantageously consists of at least one refractory oxide, preferably chosen from the group formed by alumina, silica-alumina, clay, titanium oxide, boron oxide and zirconia, taken alone or as a mixture. Preferably, the binder is chosen from alumina and silica-alumina, taken alone or as a mixture. More preferably, the binder is alumina. The alumina may advantageously be in any of its forms known to a person skilled in the art. Very preferably, the alumina is gamma alumina, for example boehmite.

Preferably, said support of said first catalyst comprises from 20% to 99% by weight of binder, preferably from 30% to 99% by weight, and very preferably between 50% and 95% by weight, and very preferably from 60% to 95% by weight, relative to the total weight of said support.

The zeolite used in the support of the first catalyst is advantageously chosen from zeolites of FAU, BEA, ISV, IWR, IWW, MEI and UWY structural type, taken alone or as a mixture, and preferably from zeolites of FAU and BEA structural type, taken alone or as a mixture.

In a preferred embodiment, the zeolite is chosen from zeolite Y and zeolite beta, taken alone or as a mixture, and preferably the zeolite is zeolite Y and very preferably dealuminated zeolite USY.

Preferably, said support of said first catalyst comprises from 1% to 80% by weight, preferably from 1% to 70% by weight, more preferably still from 5% to 50% by weight, and very preferably from 5% to 40% by weight, of at least one zeolite, relative to the total mass of said support.

Preferably, said support of said first catalyst comprises and preferably consists of:
1% to 80% by weight, preferably from 1% to 70% by weight, more preferably still from 5% to 50% by weight, and very preferably 5% to 40% by weight, of at least one zeolite, relative to the total mass of said support,
20% to 99% by weight, with preference from 30% to 99%, preferably from 50% to 95% by weight, and very preferably from 60% to 95% by weight, relative to the total mass of said support, of at least said binder.

In a preferred embodiment, the first catalyst comprises a zeolite Y alone.

In another preferred embodiment, the first catalyst comprises a zeolite USY and a zeolite beta.

Said zeolites are advantageously defined in the classification “Atlas of Zeolite Framework Types, 6th revised edition”, Ch. Baerlocher, L. B. McCusker, D. H. Olson, 6th Edition, Elsevier, 2007, Elsevier.

The zeolite Y used in the support of the first catalyst advantageously has an initial lattice parameter a0 of the unit cell of less than 24.55 Å, with preference of less than 24.45 Å and preferably of less than 24.40 A and more preferably still of less than 24.35 Å. Preferably, the initial lattice parameter a0 of the unit cell is greater than 24.24 Å and preferably greater than 24.26 Å.

The zeolite Y used in the support of the first catalyst advantageously has a specific surface area measured by nitrogen physisorption according to the BET method of between 550 and 1200 m²/g, with preference between 600 and 1100 m²/g, and preferably between 650 and 1050 m²/g.

According to a preferred embodiment of the invention, the zeolite Y suitable for the use of the support for the catalyst a) used in the process according to the invention is advantageously prepared from a zeolite Y of FAU structural type preferably having an overall Si/Al atomic ratio after synthesis of between 2.3 and 2.8 and advantageously being in NaY form after synthesis. Said zeolite Y of FAU structural type advantageously undergoes a step of one or more ion exchanges before undergoing the dealumination step. The ion exchange(s) make it possible to partially or completely replace the alkaline cations belonging to groups IA and IIA of the periodic table present in the cation position in the crude synthesis zeolite Y of FAU structural type with NH₄⁺ cations, and preferably Na⁺ cations with NH₄⁺ cations.

Partial or complete exchange of the alkaline cations with NH₄⁺ cations is understood to mean the exchange of from 80% to 100%, preferably from 85% to 99.5% and more preferably from 88% to 99%, of said alkaline cations with NH₄⁺ cations. At the end of the ion exchange step(s), the remaining amount of alkaline cations, and preferably the remaining amount of Na⁺ cations, in the zeolite Y, relative to the amount of alkaline cations, preferably Na⁺ cations, initially present in the zeolite Y, is advantageously between 0% and 20%, with preference between 0.5% and 15%, and preferably between 1.0% and 12%.

Preferably, this step implements a plurality of ion exchanges with a solution containing at least one ammonium salt chosen from chlorate, sulfate, nitrate, phosphate or acetate salts of ammonium, so as to at least partially remove the alkaline cations, and preferably the Na⁺ cations, present in the zeolite. Preferably, the ammonium salt is ammonium nitrate NH₄NO₃.

Thus, the remaining content of alkaline cations and preferably of Na⁺ cations in the zeolite Y at the end of the step of ion exchange(s) is preferably such that the alkaline cation/aluminum molar ratio, and preferably the Na/Al molar ratio, is between 0:1 and 0.005:1, and more preferably between 0:1 and 0.008:1.

The desired alkaline cation/aluminum, preferably Na/Al, ratio is obtained by adjusting the NH₄⁺ concentration of the ion exchange solution, the ion exchange temperature and the number of ion exchanges. The NH₄⁺ concentration of the ion exchange solution advantageously varies between 0.01 and 12 mol·l⁻¹, and preferably between 1.00 and 10 mol·l⁻¹. The temperature of the ion exchange step is advantageously between 20 and 100 °C, with preference between 60 and 95 °C, preferably between 60 and 90 °C, more preferably between 60 and 85 °C, and more preferably still between 60 and 80 °C. The number of ion exchanges advantageously varies between 1 and 10, and preferably between 1 and 4.

Where appropriate, said zeolite Y, preferably of FAU structural type, obtained may then undergo a dealumination treatment step. Said dealumination step may advantageously be carried out by any method known to a person skilled in the art. Preferably, the dealumination is carried out by a heat treatment optionally in the presence of steam (known as “steaming”) and/or by one or more acid attacks advantageously carried out by treatment with an aqueous mineral or organic acid solution.

Preferably, the dealumination step implements a heat treatment followed by one or more acid attacks, or just one or more acid attacks.

Preferably, the heat treatment optionally in the presence of steam, to which said zeolite Y is subjected, is carried out at a temperature of between 200 and 900 °C, preferably between 300 and 900 °C, more preferably still between 400 and 750 °C. The duration of said heat treatment is advantageously greater than or equal to 0.5 h, preferably between 0.5 h and 24 h, and very preferably between 1 h and 12 h. In the case where the heat treatment is carried out in the presence of water, the percentage by volume of steam during the heat treatment is advantageously between 5% and 100%, preferably between 20% and 100%, and very preferably between 40% and 100%. The volume fraction not made up of steam optionally present is formed of air. The flow rate of gas formed of steam and possibly air is advantageously between 0.2 l·h⁻¹·g⁻¹ and 10 |·h⁻¹·g⁻¹ of zeolite Y.

The heat treatment enables the extraction of aluminum atoms from the structure of the zeolite Y while keeping the overall Si/Al atomic ratio of the treated zeolite unchanged.

The step of heat treatment in the presence of steam may advantageously be repeated as many times as is necessary to obtain the zeolite Y suitable for implementing the support of the catalyst used in the process according to the invention and having a lattice parameter a0 of the unit cell of less than 24.55 Å, with preference of less than 24.45 Å and preferably of less than 24.40 Å and more preferably still of less than 24.35 Å.

The step of heat treatment optionally in the presence of steam is advantageously followed by an acid attack step. Said acid attack makes it possible to partially or completely remove the aluminic debris resulting from the step of heat treatment in the presence of steam which may partially block the porosity of the dealuminated zeolite; the acid attack thus makes it possible to unblock the porosity of the dealuminated zeolite.

The acid attack may advantageously be carried out by suspending the zeolite Y, which has optionally undergone a heat treatment beforehand, in an aqueous solution containing a mineral or organic acid. The mineral acid may be nitric acid, sulfuric acid, hydrochloric acid, phosphoric acid or boric acid. The organic acid may be formic acid, acetic acid, oxalic acid, tartaric acid, maleic acid, malonic acid, malic acid, lactic acid, or any other water-soluble organic acid. The mineral or organic acid concentration in the solution advantageously varies between 0.01 and 2.0 mol·l⁻¹, and preferably between 0.5 and 1.0 mol·l⁻¹. The temperature of the acid attack step is advantageously between 20 and 100 °C, with preference between 60 and 95 °C, preferably between 60 and 90 °C and more preferably between 60 and 80 °C. The duration of the acid attack is advantageously between 5 minutes and 8 hours, preferably between 30 minutes and 4 hours, and preferably between 1 hour and 2 hours.

At the end of the step(s) of heat treatment optionally in the presence of steam and optionally of the acid attack step, the process for modifying said zeolite Y advantageously includes a step of at least one partial or complete exchange of the alkaline cations, and preferably the Na⁺ cations, still present in cation position in the zeolite Y. The ion exchange step is carried out in a similar manner to the ion exchange step described above.

At the end of the step(s) of heat treatment optionally in the presence of steam and optionally of the acid attack step and optionally of the step of partial or complete exchange of the alkaline cations and preferably Na⁺ cations, the process for modifying said zeolite Y may include a calcination step. Said calcination makes it possible to remove the organic species present within the porosity of the zeolite, for example those supplied by the acid attack step or by the step of partial or complete exchange of the alkaline cations. In addition, said calcination step makes it possible to generate the protonated form of the zeolite Y and to impart upon it an acidity for the purposes of the applications thereof.

The calcination may advantageously be carried out in a muffle furnace or in a tubular furnace, under dry air or under inert atmosphere, in a swept bed or a traversed bed. The calcination temperature is advantageously between 200 and 800 °C, with preference between 450 and 600 °C, and preferably between 500 and 550 °C. The duration of the calcination hold is advantageously between 1 and 20 hours, with preference between 6 and 15 hours, and preferably between 8 and 12 hours.

Thus, said zeolite Y obtained has an initial lattice parameter a0 of the unit cell of less than 24.55 Å, with preference of less than 24.45 Å and preferably of less than 24.40 Å and more preferably still of less than 24.35 Å and a specific surface area measured by nitrogen physisorption according to the BET method of between 550 and 1200 m²/g, with preference between 600 and 1100 m²/g, and preferably between 650 and 1050 m²/g.

In the preferred embodiment in which the support of the first catalyst also comprises, in addition to the zeolite USY, a zeolite beta, the zeolite beta preferably has an overall SiO2/Al2O3 molar ratio or SAR of between 10 and 100, preferentially between 20 and 50, and preferably between 20 and 30. The zeolite beta used in the support of the first catalyst according to the invention advantageously has a specific surface area measured by nitrogen physisorption according to the BET method of between 400 and 800 m²/g, with preference between 500 and 750 m²/g, and preferably between 550 and 700 m²/g.

The zeolite beta is generally synthesized from a reaction mixture containing a structuring agent. The use of structuring agents is well known to a person skilled in the art: for example, patent U.S. Pat. No. 3,308,069 describes the use of tetraethylammonium hydroxide, and patent U.S. Pat. No. 5,139,759 describes the use of the tetraethylammonium cation derived from a tetraethylammonium halide compound. Another standard method for preparing zeolite beta is given in the book “Verified Synthesis of Zeolitic Materials”.

In said preferred embodiment in which the support of the first catalyst comprises a zeolite USY and a zeolite beta, said first catalyst comprises and preferably consists of:
0.9% to 79.9%, with preference from 1% to 70%, and preferably from 5% to 50%, and very preferably from 5% to 40% by weight, relative to the total weight of said support, of a zeolite Y having an initial lattice parameter a0 of the unit cell of less than 24.55 Å;
0.1% to 6%, with preference 0.2% to 5%, and preferably 0.5% to 5% by weight, relative to the total weight of said support, of a zeolite beta; and
from 20% to 99% by weight, with preference from 30% to 99% by weight, and very preferably from 50% to 95% by weight, and more preferably still from 60% to 95% by weight, relative to the total weight of said support, of at least one binder.

In accordance with step b) of the process according to the invention, all of the effluent resulting from step a) is contacted, in a second catalytic zone, without an intermediate separation step between the first and the second catalytic zone, with a second catalyst comprising at least one metal from group VIB and/or at least one metal from group VIII of the periodic table and a support comprising at least one zeolite of BEA structure code and at least one binder.

Preferably, the effluent resulting from step a) is sent into a second catalytic zone without an intermediate gas/liquid separation step.

Preferably, the second catalyst used in the second catalytic zone of hydrocracking step b) comprising at least one metal from group VIB and at least one metal from group VIII of the periodic table, taken alone or as a mixture, is preferably a catalyst in sulfide form.

Preferably, the metals from group VIB of the periodic table are chosen from the group formed by tungsten and molybdenum, taken alone or as a mixture. According to a preferred embodiment, the metal from group VIB is molybdenum. According to another preferred embodiment, the metal from group VIB is tungsten.

Preferably, the non-noble metals from group VIII of the periodic table are chosen from the group formed by cobalt and nickel, taken alone or as a mixture. According to a preferred embodiment, the non-noble metal from group VIII is cobalt. According to another preferred embodiment, the non-noble metal from group VIII is nickel.

Preferably, said second catalyst comprises at least one metal from group VIB in combination with at least one non-noble metal from group VIII, the non-noble metals from group VIII being chosen from the group formed by cobalt and nickel, taken alone or as a mixture, and the metals from group VIB being chosen from the group formed by tungsten and molybdenum, taken alone or as a mixture.

In one embodiment, the following combinations of metals are used: nickel-molybdenum, cobalt-molybdenum, nickel-tungsten, cobalt-tungsten; the preferred combinations are: nickel-molybdenum and nickel-tungsten.

In the case where the second catalyst comprises at least one metal from group VIB in combination with at least one non-noble metal from group VIII, the content of metal from group VIB, as oxide equivalent, is advantageously between 5% and 40% by weight relative to the total mass of said catalyst, preferably between 10% and 35% by weight and very preferably between 15% and 30% by weight, and the content of non-noble metal from group VIII, as oxide equivalent, is advantageously between 0.5% and 10% by weight relative to the total mass of said catalyst, preferably between 1% and 8% by weight and very preferably between 1.5% and 6% by weight.

In the case where the second catalyst comprises at least one metal from group VIB in combination with at least one non-noble metal from group VIII, said catalyst is a sulfided catalyst.

It is also possible to use combinations of three metals, for example nickel-cobalt-molybdenum, nickel-molybdenum-tungsten, nickel-cobalt-tungsten.

In one embodiment, the following combinations of metals are used: nickel-niobium-molybdenum, cobalt-niobium-molybdenum, nickel-niobium-tungsten, cobalt-niobium-tungsten, the preferred combinations being: nickel-niobium-molybdenum, cobalt-niobium-molybdenum. It is also possible to use combinations of four metals, for example nickel-cobalt-niobium-molybdenum.

The catalyst may advantageously also comprise at least one doping element chosen from the group consisting of boron and phosphorus, and preferably phosphorus.

The second catalyst may also advantageously contain:
from 0.1% to 15% by weight of oxide, preferably from 0.1% to 10% by weight, relative to the total mass of the catalyst, of at least one doping element chosen from the group consisting of boron and phosphorus, and preferably phosphorus,
from 0% to 60% by weight, preferably from 0.1% to 50% by weight, and more preferably still from 0.1% to 40% by weight of oxide, relative to the total mass of the catalyst, of at least one element chosen from group VB and preferably niobium,
from 0% to 20% by weight, preferably from 0.1% to 15% by weight and more preferably still from 0.1% to 10% by weight of oxide, relative to the total mass of the catalyst, of at least one element chosen from group VIIA, and preferably fluorine.

In accordance with the invention, the support of the second catalyst used in the second catalytic zone of hydrocracking step b) according to the invention comprises at least one zeolite of BEA structure code and at least one binder.

Preferably, the zeolite of BEA structure code is a zeolite beta and preferably a zeolite beta having an overall silica-to-alumina molar ratio SAR of between 10 and 300, preferentially between 10 and 100, preferably between 10 and 50, preferably between 10 and 30, more preferably between 10 and 25, more preferably still between 12 and 24 and more preferably still between 15 and 24.

The zeolite beta is generally synthesized from a reaction mixture containing a structuring agent. The use of structuring agents is well known to a person skilled in the art: for example, patent U.S. Pat. No. 3,308,069 describes the use of tetraethylammonium hydroxide, and patent U.S. Pat. No. 5,139,759 describes the use of the tetraethylammonium cation derived from a tetraethylammonium halide compound. Another standard method for preparing zeolite beta is given in the book “Verified Synthesis of Zeolitic Materials” (Elsevier, 2001).

The zeolite beta used in the support of the second catalyst according to the invention advantageously has an average crystal size of less than 500 nm, preferably of less than 350 nm. Advantageously, these crystals may be in the form of agglomerates with a size possibly ranging up to 50 μm, preferably of less than 25 μm. Furthermore, the zeolite beta used in the support of the catalyst b) according to the invention has a specific surface area measured by nitrogen physisorption according to the BET method of between 500 and 800 m²/g, with preference between 500 and 750 m²/g, and preferably between 550 and 720 m²/g, a mesopore volume of greater than 0.2 ml/g, with preference of greater than 0.40 ml/g, determined by BJH and an external surface area of at least 120 m²/g, with preference at least 140 m²/g, very preferably at least 150 m²/g and more preferably still of between 150 and 300 m²/g. Lastly, preferably, the proportion of external surface area relative to the total BET surface area of the zeolite beta included in the support of the catalyst b) is between 15% and 50%, very preferably between 18% and 40% and more preferably still between 21% and 37%.

The binder used in the support of the second catalyst, also referred to as porous mineral matrix, advantageously consists of at least one refractory oxide, preferably chosen from the group formed by alumina, silica-alumina, clay, titanium oxide, boron oxide and zirconia, taken alone or as a mixture. Preferably, the binder is chosen from alumina and silica-alumina, taken alone or as a mixture. More preferably, the binder is alumina. The alumina may advantageously be in any of its forms known to a person skilled in the art. Very preferably, the alumina is gamma alumina, for example boehmite.

Preferably, said support of said second catalyst comprises from 20% to 99% by weight of binder, preferably from 30% to 99% by weight, and very preferably between 50% and 95% by weight, and very preferably from 60% to 95% by weight, relative to the total weight of said support.

Preferably, said support of the second catalyst comprises and preferably consists of:
1% to 70% by weight, with preference from 1% to 50% by weight, preferably from 1.5% to 40% by weight, and more preferably still 2% to 30% by weight, of said zeolite beta, relative to the total mass of said support,
30% to 99% by weight, with preference from 50% to 99%, preferably from 60% to 98% by weight, and very preferably from 70% to 98% by weight, relative to the total mass of said support, of at least said binder.

The second catalyst used in step b) of the process according to the invention may advantageously contain at least one other zeolite in the support of said second catalyst. If applicable, the other zeolite(s) are advantageously chosen from zeolites having at least one series of channels the opening of which is defined by a ring of 12 oxygen atoms (12MR), in particular from zeolites of FAU, BEA, ISV, IWR, IWW, MEI, UWY, MFI and MTW structural type or zeolite IZM-2, taken alone or as a mixture, and preferably from zeolites of FAU and BEA structural type, taken alone or as a mixture. Preferably, the second catalyst may comprise, in addition to the zeolite of BEA structure code, another zeolite of FAU structure code and preferably a zeolite Y.

Preferably, the zeolite Y which may be used in the second catalyst has an initial lattice parameter a0 of the unit cell of less than 24.55 Å, with preference of less than 24.45 Å and preferably of less than 24.40 Å and more preferably still of less than 24.35 Å and a specific surface area measured by nitrogen physisorption according to the BET method of between 550 and 1200 m²/g, with preference between 600 and 1100 m²/g, and preferably between 650 and 1050 m²/g.

Preferably, said zeolite Y may be prepared according to a process identical to that described for the zeolite Y used in step a) of the process according to the invention.

In this case, the support of the second catalyst used in the process according to the invention comprises at least one zeolite of BEA structure code and at least one zeolite Y, and at least one binder, said support comprising and preferably consisting of, preferably:
1% to 50% by weight, with preference from 1% to 30% by weight, preferably from 1.5% to 20% by weight, and more preferably still 2% to 30% by weight, of said zeolite beta, relative to the total mass of said support,
0.5% to 50% by weight, with preference from 1% to 30% by weight, preferably from 1.5% to 10% by weight, and more preferably still 2% to 5% by weight, of said zeolite Y, relative to the total mass of said support,
30% to 98.5% by weight, with preference from 40% to 98%, preferably from 70% to 97% by weight, and very preferably from 65% to 96% by weight, relative to the total mass of said support, of at least said binder.

In this case, the second catalyst used in step b) of the process according to the invention is preferably different from the first catalyst used in step a) of said process.

In the hydrocracking step, the volume fraction of the first catalyst used in step a) relative to the whole of the two catalysts used in steps a) and b) is preferably between 50% and 95% by volume, and preferably between 60% and 95% by volume, very preferably between 65% and 90% by volume, and more preferably still between 65% and 85% by volume.

Preferably, the volume fraction of the second catalyst used in step b) relative to the whole of the two catalysts used in steps a) and b) is between 5% and 50% by volume, and preferably between 5% and 40% by volume, very preferably between 10% and 35% by volume, and more preferably still between 15% and 35% by volume.

The process for producing middle distillates according to the invention may advantageously be implemented according to any of the embodiments known in the prior art.

Said process may advantageously be implemented in one or two steps, in one or more reactor(s), in a fixed bed or in an ebullated bed. It may be carried out with or without recycle, after said hydrotreatment step aiming to remove any sulfur, nitrogen or oxygen compounds possibly present in the feedstocks. In the case where a recycle is carried out, this may be performed at any location in the process, either in the hydrotreatment step or in the first catalytic zone of hydrocracking step a).

In one embodiment of the “2-step” hydrocracking step, the effluent resulting from step b) of the hydrocracking step is sent into a fractionating column in order to recover at least a middle distillates cut and at least a heavy cut comprising unconverted compounds, and said heavy cut is advantageously sent either into a second step of hydrocracking in the presence of hydrogen and of a hydrocracking catalyst or into hydrotreatment step a).

### Preparation of the First and Second Catalysts According to the Invention

The first and second catalysts used respectively in step a) and step b) of the hydrocracking step of the process according to the invention are advantageously prepared according to the conventional methods used in the prior art.

In particular, the catalyst(s) is (are) prepared according to a preparation process comprising:
a step of preparing the support, comprising:
mixing at least one porous mineral matrix with:

In the case of the first catalyst, at least one zeolite having at least one series of channels the opening of which is defined by a ring of 12 oxygen atoms (12MR),
In the case of the second catalyst, at least one zeolite of BEA structure code with an SAR of less than 25,
and
shaping said mixture;
introducing at least one hydrogenating-dehydrogenating element chosen from the group formed by the elements from group VIB of the periodic table, preferably molybdenum and tungsten, the non-noble elements from group VIII of the periodic table, preferably cobalt, nickel, and mixtures thereof, and preferably nickel and cobalt, and mixtures thereof, onto the support by:
adding at least one precursor of said element during the shaping so as to introduce at least a portion of said element, and/or
impregnating the support with at least one precursor of said element,
optionally a step of drying and/or calcining at the end of the preparation of the support and/or of the step of introducing at least one hydrogenating-dehydrogenating element.

More particularly, the first catalyst is prepared according to a preparation process comprising the following steps:
preparing the zeolite having at least one series of channels the opening of which is defined by a ring of 12 oxygen atoms (12MR) according to processes known from the prior art, preferably a zeolite Y,
mixing with a porous mineral matrix and shaping to obtain the support,
introducing at least one hydrogenating-dehydrogenating element onto the support by at least one of the following methods: (i) adding at least one precursor of said element during the shaping so as to introduce at least a portion of said element, (ii) impregnating the support with at least one precursor of said hydrogenating-dehydrogenating element, optionally drying and/or calcining the products obtained at the end of each of the abovementioned preparation steps.

Analogously, more particularly, the second catalyst is prepared according to a preparation process comprising the following steps:
preparing the zeolite of BEA structure code with an SAR of less than 25 according to processes known from the prior art,
mixing with a porous mineral matrix and shaping to obtain the support,
introducing at least one hydrogenating-dehydrogenating element onto the support by at least one of the following methods: (i) adding at least one precursor of said element during the shaping so as to introduce at least a portion of said element, (ii) impregnating the support with at least one precursor of said hydrogenating-dehydrogenating element, optionally drying and/or calcining the products obtained at the end of each of the abovementioned preparation steps.

Preferably, the porous mineral matrix is derived from an alumina gel which has a crystallite size of between 2 and 35 nm.

Preferably, the alumina gel used comprises a sulfur content of between 0.001% and 1% by weight, preferably between 0.001% and 0.40% by weight, very preferably between 0.003% and 0.33% by weight, and more preferably between 0.005% and 0.25% by weight.

Preferably, the alumina gel used comprises a sodium content of between 0.001% and 1% by weight, preferably between 0.001% and 0.15% by weight, very preferably between 0.0015% and 0.10% by weight, and 0.002% and 0.040% by weight.

The alumina gel used advantageously has a high degree of dispersibility which makes it possible to facilitate the step of shaping said gel according to any of the methods known to a person skilled in the art and in particular by kneading extrusion, by granulation, and by the technique known as the oil drop technique.

Said alumina has a specific surface area and a pore distribution calibrated and adapted to its use in a process for hydrocracking said hydrocarbon feedstock.

Preferably, the alumina is purely mesoporous and devoid of micropores.

Preferably, the support advantageously has a specific surface area of greater than 100 m²/g, and a mesopore volume of greater than or equal to 0.5 ml/g, preferably of greater than or equal to 0.6 ml/g.

The mesopore volume of the support is defined as being the volume comprised in the pores having an average diameter of between 2 and 50 nm and is measured using the mercury intrusion method.

Preferably, the alumina thus prepared and used in the invention is a non-mesostructured alumina.

The support may advantageously be shaped by any technique known to a person skilled in the art. The shaping may be carried out, for example, by extrusion, by pelletization, by the oil-drop coagulation method, by rotating plate granulation, or by any other method well known to a person skilled in the art.

The support is preferably formed into grains of various shapes and sizes. They are generally used in the form of cylindrical extrudates or polylobal extrudates, such as trilobal, quadrilobal or polylobal extrudates, of straight or twisted form, but may optionally be manufactured and employed in the form of crushed powders, tablets, rings, beads or wheels. However, it is advantageous for the catalyst to be in the form of extrudates with a diameter of between 0.5 and 5 mm and more particularly between 0.7 and 3 mm and more particularly still between 1.0 and 2.5 mm. The shapes are cylindrical (which may or may not be hollow), twisted cylindrical, multilobal (for example 2, 3, 4 or 5 lobes) or rings. Any other shape may be used.

One of the preferred shaping methods consists in co-kneading said zeolites with the binder, preferably alumina, in the form of a wet gel for a few tens of minutes, preferably between 10 and 40 minutes, then passing the paste thus obtained through a die to form extrudates with a diameter preferably between 0.5 and 5 mm.

According to another of the preferred forming methods, said zeolites may be introduced during the synthesis of the porous mineral matrix. For example, according to this preferred embodiment of the present invention, said zeolites, preferably Y and optionally beta, are added during the synthesis of a porous mineral matrix, for instance a silico-aluminic matrix: in this case, said zeolites may advantageously be added to a mixture composed of an alumina compound in an acidic medium with a completely soluble silica compound.

In accordance with the invention, the raw material obtained at the end of the shaping step then undergoes a step of calcination at a temperature of between 500 and 1000 °C, for a duration of between 2 and 10 h, in the presence or absence of a stream of air containing up to 60% by volume of water.

Preferably, said calcination step is performed at a temperature of between 540 °C and 850 °C.

Preferably, said calcination step is performed for a duration of between 2 h and 10 h.

When the binder is an alumina gel, otherwise identified as a boehmite, said calcination step allows the transition from the boehmite to the final alumina.

The elements from group VIB and/or VIII may optionally be introduced during the shaping step, by adding at least one compound of said element, so as to introduce at least a portion of said element.

The introduction of at least one hydrogenating-dehydrogenating element may advantageously be accompanied by the introduction of at least one promoter element chosen from phosphorus, boron, silicon and preferably phosphorus and optionally by the introduction of an element from group VIIA and/or VB. The shaped solid is optionally dried at a temperature of between 60 and 250 °C and optionally calcined at a temperature of from 250 to 800 °C for a duration of between 30 minutes and 6 hours.

The step of introducing at least one hydrogenating-dehydrogenating element is advantageously carried out by a method well known to a person skilled in the art, in particular by one or more operations of impregnating the shaped and calcined or dried, and preferably calcined, support with a solution containing the precursors of the elements from group VIB and/or VIII, optionally the precursor of at least one promoter element and optionally the precursor of at least one element from group VIIA and/or group VB.

Preferably, said introduction is carried out by a method of dry impregnation with a solution containing the precursors of the hydrogenating/dehydrogenating function, that is to say of the elements from group VIB and/or VIII, optionally followed a drying step and preferably without a calcination step.

In the case where the catalyst of the present invention contains a non-noble metal from group VIII, the metals from group VIII are preferably introduced by one or more operations of impregnation of the shaped and calcined support, after those of group VIB or at the same time as the latter.

The introduction of at least one hydrogenating-dehydrogenating element may then optionally be followed by drying at a temperature of between 60 and 250 °C and optionally by a calcination at a temperature of between 250 and 800 °C.

The sources of molybdenum and tungsten are advantageously chosen from the oxides and hydroxides, molybdic and tungstic acids and salts thereof, in particular the ammonium salts such as ammonium molybdate, ammonium heptamolybdate and ammonium tungstate, phosphomolybdic acid, phosphotungstic acid and salts thereof, silicomolybdic acid, silicotungstic acid and salts thereof. Preference is given to using the oxides and the ammonium salts, such as ammonium molybdate, ammonium heptamolybdate and ammonium tungstate.

The sources of non-noble elements from group Vill that may be used are well known to a person skilled in the art. For example, for the non-noble metals, use will be made of nitrates, sulfates, hydroxides, phosphates, halides, for instance chlorides, bromides and fluorides, carboxylates, for instance acetates and carbonates.

The preferred phosphorus source is orthophosphoric acid H₃PO₄, but salts and esters thereof, such as ammonium phosphates, are also suitable. The phosphorus may be introduced, for example, in the form of a mixture of phosphoric acid and a basic organic compound containing nitrogen such as aqueous ammonia, primary and secondary amines, cyclic amines, compounds of the pyridine and quinoline families and compounds of the pyrrole family. Tungstophosphoric or tungstomolybdic acids may be used.

The phosphorus content is adjusted, without this limiting the scope of the invention, so as to form a mixed compound in solution and/or on the support, for example tungsten-phosphorus or molybdenum-tungsten-phosphorus. These mixed compounds may be heteropolyanions. These compounds may be Anderson heteropolyanions, for example.

The boron source may be boric acid, preferably orthoboric acid H₃BO₃, ammonium diborate or pentaborate, boron oxide or boric esters. The boron may be introduced, for example, in the form of a mixture of boric acid, aqueous hydrogen peroxide solution and a basic organic compound containing nitrogen such as aqueous ammonia, primary and secondary amines, cyclic amines, compounds of the pyridine and quinoline families and compounds of the pyrrole family. The boron may be introduced, for example, by a solution of boric acid in a water/alcohol mixture.

The sources of elements from group VB that may be used are well known to a person skilled in the art. For example, among the sources of niobium, use may be made of the oxides, such as diniobium pentoxide Nb₂O₅, niobic acid Nb₂O₅·H₂O, niobium hydroxides and polyoxoniobates, niobium alkoxides of formula Nb(OR1)₃ where R1 is an alkyl radical, niobium oxalate NbO(HC₂O₄)₅, or ammonium niobate. Preference is given to using niobium oxalate or ammonium niobate.

The sources of elements from group VIIA that may be used are well known to a person skilled in the art. For example, fluoride anions may be introduced in the form of hydrofluoric acid or salts thereof. These salts are formed with alkali metals, ammonium or an organic compound.

In the latter case, the salt is advantageously formed in the reaction mixture by reaction between the organic compound and hydrofluoric acid. It is also possible to use hydrolysable compounds which can release fluoride anions in water, such as ammonium fluorosilicate (NH₄)₂SiF₆, silicon tetrafluoride SiF₄ or sodium fluorosilicate Na₂SiF₆. The fluorine may be introduced, for example, by impregnation of an aqueous solution of hydrofluoric acid or of ammonium fluoride.

An organic additive may optionally be added to any step of preparation of said catalyst and preferably to the impregnation solution alone or with the various metal precursors.

Prior to injecting the feedstock, the catalysts used in the processes according to the present invention are subjected to a sulfidation treatment for converting, at least in part, the metallic species to sulfide before they are brought into contact with the feedstock to be treated. This treatment of activation by sulfidation is well known to a person skilled in the art and can be performed by any method already described in the literature, either in situ, i.e. in the reactor, or ex situ. This treatment may be carried out simultaneously for the two catalysts used in the process or successively.

A conventional sulfidation method well known to a person skilled in the art consists in heating the catalyst in the presence of hydrogen sulfide (pure or for example under a stream of a hydrogen/hydrogen sulfide mixture) at a temperature of between 150 and 800 °C, preferably between 250 and 600 °C, generally in a flow-through bed reaction zone.

The invention is illustrated by the following examples, which are not in any way limiting.

### EXAMPLES

### Example 1: Preparation of a Support S1 Comprising a Zeolite Y and a Zeolite Beta

The support S1 is prepared by kneading-extrusion of 15% by weight of commercial zeolite USY having a lattice parameter of 24.30 Å, an SiO2/Al₂O₃ molar ratio (SAR) of 30, a specific surface area measured by nitrogen physisorption according to the BET method of 890 m²/g, 5% by weight of commercial zeolite beta having an SiO2/Al₂O₃ molar ratio of 24, a specific surface area measured by nitrogen physisorption according to the BET method of 670 m²/g, in the presence of commercial boehmite (Pural SB3 from Sasol). The extrudates obtained are dried at 80 °C and then calcined at 600 °C under humid air (5% by weight of water per kg of dry air). The calcined support comprises, on a dry basis, 15% by weight of zeolite USY, 5% by weight of zeolite beta and 80% by weight of alumina.

### Example 2: Preparation of a Support S2 Comprising a Zeolite Beta with SAR<25

The support S2 is prepared by kneading-extrusion of 5% by weight of commercial zeolite beta having an SiO2/Al2O3 molar ratio of 24, a specific surface area measured by nitrogen physisorption according to the BET method of 670 m²/g, in the presence of commercial boehmite (Pural SB3 from Sasol). The extrudates obtained are dried at 80 °C and then calcined at 600 °C under humid air (5% by weight of water per kg of dry air). The calcined support comprises, on a dry basis, 5% by weight of zeolite beta and 95% by weight of alumina.

### Example 3: Preparation of a Support S3 Comprising a Zeolite Y

The support S3 is prepared by kneading-extrusion of 20% by weight of commercial zeolite USY having a lattice parameter of 24.30 Å, an SiO2/Al₂O₃ molar ratio of 30, a specific surface area measured by nitrogen physisorption according to the BET method of 890 m²/g, in the presence of commercial boehmite (Pural SB3 from Sasol). The extrudates obtained are dried at 80 °C and then calcined at 600 °C under humid air (5% by weight of water per kg of dry air). The calcined support comprises, on a dry basis, 20% by weight of zeolite USY and 80% by weight of alumina.

### Example 4: Preparation of a Support S4 (in Accordance) Comprising a Zeolite Beta with SAR>200

The support S2 is prepared by kneading-extrusion of 5% by weight of commercial zeolite beta having an SiO₂/Al₂O₃ molar ratio of 250, a specific surface area measured by nitrogen physisorption according to the BET method of 580 m²/g, in the presence of commercial boehmite (Pural SB3 from Sasol). The extrudates obtained are dried at 80 °C and then calcined at 600 °C under humid air (5% by weight of water per kg of dry air). The calcined support comprises, on a dry basis, 5% by weight of zeolite beta and 95% by weight of alumina.

### Example 5: Preparation of an Aluminic Support S5

The support S2 is prepared by kneading-extrusion of commercial boehmite (Pural SB3 from Sasol). The extrudates obtained are dried at 80 °C and then calcined at 600 °C under humid air (5% by weight of water per kg of dry air). The calcined support therefore does not comprise zeolite.

### Example 6: Preparation of the Catalysts

C1: NiMoP supported on S1 (USY+beta),
C2: NiMoP supported on S2 (beta alone having an SAR=24),
C3: NiMoP supported on S3 (USY),
C4: NiMoP supported on S4 (beta alone having an SAR=250),
C5: NiMoP supported on S5 alumina without zeolite.

The catalysts C1, C2, C3 and C4 are prepared in the same way by dry impregnation of the supports S1, S2, S3 and S4 respectively using an aqueous solution containing the elements Ni, Mo. This solution is obtained by dissolving the following precursors in water: nickel nitrate and ammonium heptamolybdate. The amount of precursors in solution is adjusted as a function of the targeted concentrations on the final catalyst. After dry impregnation, the catalyst is dried at 120 °C under air.

The catalyst C5 is prepared in two stages. A catalyst C5_int is first prepared from the support S5 analogously to the catalysts C1 to C4, but with different target contents and similar drying. This catalyst C5_Int is then dry impregnated with a solution of triethylene glycol such that the TEG/Mo molar ratio is 0.5 mol/mol and that the volume makeup composed of the solvent consists of 50% v/v of water and 50% v/v of ethanol. The final catalyst C5 is obtained after a final step of drying at 100 °C.

The percentages by mass in the catalyst are those indicated in the table below:

TABLE 1

| Catalysts | C1 | C2 | C3 | C4 | C5 |
|---|---|---|---|---|---|
| MoO3 (% by | 17.1 | 17.2 | 17.1 | 17.3 | 23.6 |
| dry weight) | | | | | |
| NiO (% by | 3.8 | 3.7 | 3.7 | 3.9 | 4.6 |
| dry weight) | | | | | |

Example 7 (comparative): hydrocracking of a mixture comprising 83% by weight of vacuum distillate and 17% by weight of animal fat, over the sequence of a hydrotreatment catalyst followed by the hydrocracking catalyst based on a zeolite USY and a zeolite beta.

Example 8 (comparative): hydrocracking of a mixture comprising 83% by weight of vacuum distillate and 17% by weight of animal fat, over the sequence of a hydrotreatment catalyst followed by the hydrocracking catalyst based on a zeolite USY alone.

Example 9 (in accordance): hydrocracking of a mixture comprising 83% by weight of vacuum distillate and 17% by weight of animal fat, over the sequence of a hydrotreatment catalyst followed by the first hydrocracking catalyst based on a zeolite USY and a zeolite beta, followed by a second hydrocracking catalyst based on a zeolite beta having an SAR of 250. The proportion by volume of the first hydrocracking catalyst and of the second hydrocracking catalyst is 75% and 25% by volume, respectively.

Example 10 (in accordance): hydrocracking of a mixture comprising 83% by weight of vacuum distillate and 17% by weight of animal fat, over the sequence of a hydrotreatment catalyst followed by the first hydrocracking catalyst based on a zeolite USY alone, followed by a second hydrocracking catalyst based on a zeolite beta having an SAR of 250. The proportion by volume of the first hydrocracking catalyst to the second hydrocracking catalyst is 75% by volume to 25% by volume.

Example 11 (in accordance): hydrocracking of a mixture comprising 83% by weight of vacuum distillate and 17% by weight of animal fat, over the sequence of a hydrotreatment catalyst followed by the first hydrocracking catalyst based on a zeolite USY and a zeolite beta, followed by a second hydrocracking catalyst based on a zeolite beta having an SAR of 24. The proportion by volume of the first hydrocracking catalyst to the second hydrocracking catalyst is 75% by volume to 25% by volume.

Example 12 (in accordance): hydrocracking of a mixture comprising 83% by weight of vacuum distillate and 17% by weight of animal fat, over the sequence of a hydrotreatment catalyst followed by the first hydrocracking catalyst based on a zeolite USY alone, followed by a second hydrocracking catalyst based on a zeolite beta having an SAR of 24. The proportion by volume of the first hydrocracking catalyst to the second hydrocracking catalyst is 75% by volume to 25% by volume.

For examples 7 to 12, the characteristics of the feedstock of the mixture comprising 83% by weight of vacuum distillate and 17% by weight of animal fat are given in table 2.

The feedstock, before being injected into the hydrocracking step, is pretreated with a hydrotreatment catalyst at a total pressure of 14 MPa and at a temperature and HSV pair that makes it possible to obtain an organic nitrogen content of 10 ppm in the hydrotreated feedstock, i.e. at the inlet of hydrocracking catalytic beds.

All of the hydrotreated effluent coming from the hydrotreatment section is sent directly to the hydrocracking section without an intermediate separation step. The temperatures of the hydrocracking catalysts are controlled to achieve a total conversion of the 370 °C+ cut of 86% by weight.

In examples 9 to 12, the ratio by volume of the first hydrocracking catalyst to the second hydrocracking catalyst is set at 75/25% by volume. There is no intermediate separation of the effluent between these two hydrocracking catalysts.

All of the examples are compared at the same total pressure of 14 MPa, at the same total volume of catalysts and at the same feedstock flow rate.

The performance of the process is evaluated on the following points:
the converting activity via the weighted average temperature of the hydrocracking sections 1 and 2 together necessary to achieve 86% total conversion of the 370 °C+ cut, or the WABT (weighted average bed temperature) (table 3),
the yield of kerosene 150-280 °C (table 2),
and the cold flow properties (via the crystal disappearance point of the kerosene and the cloud point of the gas oil) (table 2).

The yields of main products given in table 2 are calculated relative to the liquid feedstock, i.e. the mixture comprising 83% by weight of vacuum distillate and 17% by weight of animal fat before the hydrotreatment step. It should be noted that the sum of the yields given in table 3 does not amount to 100% (but to 98.7%) because the yields of coproducts (H₂S, NH₃, CO, CO₂ and water) and the hydrogen consumption are not reported in table 3, since these are not different from one system to another because they are produced during the hydrotreatment step which is identical for all the systems compared.

### Characteristics of the Mixture of Vacuum Distillate and Animal Fat

TABLE 2

| | | | | Vacuum |
|---|---|---|---|---|
| | | | | distillate + AF |
| | | Animal | Vacuum | (83/17% |
| | | fat (AF) | distillate | by weight) |
| Density at 15 °C | g/ml | 0.9165 | 0.9284 | 0.9262 |
| Carbon | % by weight | 77.00 | 85.6 | 84.3 |
| Hydrogen | % by weight | 11.89 | 12.32 | 12.18 |
| Oxygen | % by weight | 11.06 | 0.17 | 2.00 |
| Sulfur | ppm | 6.3 | 18920 | 15200 |
| Nitrogen | ppm | 9.2 | 1395 | 903 |
| Monoglycerides | % by weight | <0.1 | | |
| Diglycerides | % by weight | 3.1 | | |
| Triglycerides | % by weight | 93.1 | | |
| Acid number | | 10.2 | | |
| Free fatty acid | % by weight | 3.3 | | |
| C16:0 | % by weight | 21.1 | | |
| C16:1, C16:2 | % by weight | 3.9 | | |
| C18:0 | % by weight | 5.9 | | |
| C18:1, C18:2 | % by weight | 50.0 | | |
| C18:2 | % by weight | 12.6 | | |
| C18:3 | % by weight | 1.0 | | |
| C20:1 | % by weight | 1.0 | | |
| Σ C16. % | % by weight | 25.0 | | |
| Σ C18. % | % by weight | 69.5 | | |
| SD 0.5% by weight | °C | 340 | 316 | 316 |
| SD 5% by weight | °C | 523 | 394 | 394 |
| SD 10% by weight | °C | 569 | 413 | 415 |
| SD 20% by weight | °C | 600 | 436 | 438 |
| SD 30% by weight | °C | 607 | 450 | 455 |
| SD 40% by weight | °C | 609 | 466 | 473 |
| SD 50% by weight | °C | 611 | 480 | 493 |
| SD 60% by weight | °C | 612 | 498 | 515 |
| SD 70% by weight | °C | 613 | 515 | 540 |
| SD 80% by weight | °C | 616 | 537 | 572 |
| SD 90% by weight | °C | 618 | 563 | 605 |
| SD 95% by weight | °C | 619 | 581 | 610 |
| SD 99.5% by weight | °C | 628 | 625 | 628 |

“SD” as Simulated Distillation.

### Operating Conditions and Performance of the Process of Examples 7-12

TABLE 3

| | | | Example 9: | Example 10: | Example 11. | Example 12: |
|---|---|---|---|---|---|---|
| | | | In accordance | In accordance | In accordance | In accordance |
| | Example 7: | Example 8. | with the | with the | with the | with the |
| | Comparative | Comparative | invention | invention | invention | invention |
| Hydrotreatment section | | | | | | |
| Catalyst | NiMoP/Al₂O₃ | NiMoP/Al₂O₃ | NiMoP/Al₂O₃ | NiMoP/Al₂O₃ | NiMoP/Al₂O₃ | NiMoP/Al₂O₃ |
| HSV, h⁻¹ | 1 | 1 | 1 | 1 | 1 | 1 |
| Hydrocracking section 1 | | | | | | |
| Catalyst | NiMoP/USY + | NiMoP/USY | NiMoP/USY + | NiMoP/USY | NiMoP/USY + | NiMoP/USY |
| | Beta on Al₂O₃ | on Al2O3 | Beta on Al₂O₃ | on Al₂O₃ | Beta on Al₂O₃ | on Al₂O₃ |
| Temperature, °C | 395 | 397 | 392 | 394 | 392 | 394 |
| HSV, h⁻¹ | Base | Base | Base × 1.33 | Base × 1.33 | Base × 1.33 | Base × 1.33 |
| Hydrocracking section 2 | | | | | | |
| Catalyst | — | — | NiMoP/5% Beta | NiMoP/5% Beta | NiMoP/5% Beta | NiMoP/5% Beta |
| | | | on Al2O3, with | on Al2O3, with | on Al2O3 with | on Al2O3 with |
| | | | BEA SAR = 250 | BEA SAR = 250 | BEA SAR = 24 | BEA SAR = 24 |
| Temperature, °C | — | — | 416 | 421 | 408 | 413 |
| HSV, h⁻¹ | — | — | Base × 4 | Base × 4 | Base × 4 | Base × 4 |
| Process performance | | | | | | |
| Total conversion of the 370 °C+ cut, % | 86 | 86 | 86 | 86 | 86 | 86 |
| Overall hydrocracking section HSV, h⁻¹ | base | base | Base | Base | Base | Base |
| WABT (average temperature), °C of | 395 | 397 | 398 | 401 | 396 | 399 |
| hydrocracking sections 1 and 2 together | | | | | | |
| Nitrogen at the HDT section outlet, ppm | 10 | 10 | 10 | 10 | 10 | 10 |
| Net total conversion of the | 86 | 86 | 86 | 86 | 86 | 86 |
| 370 °C+ cut, % | | | | | | |
| Yield | | | | | | |
| C1-C4 gas, % m/m feedstock | 6.5 | 4.6 | 5.2 | 4.9 | 4.7 | 4.4 |
| Light gasoline (IBP-80 °C), | 6.7 | 5.9 | 10.2 | 9.6 | 8.7 | 8.5 |
| % m/m feedstock | | | | | | |
| Heavy gasoline (80-150 °C), | 15.2 | 17.1 | 15.6 | 15.0 | 15.6 | 15.6 |
| % m/m feedstock | | | | | | |
| Middle distilate (150-370 °C), | 56 | 57.8 | 54.4 | 55.9 | 56.4 | 56.9 |
| % m/m feedstock | | | | | | |
| Kerosene (150-280 °C), | 33.6 | 34.6 | 33.7 | 34.8 | 34.9 | 35.2 |
| % m/m feedstock | | | | | | |
| Gas oil (280-370 °C), | 22.4 | 23.2 | 20.7 | 21.1 | 21.5 | 21.7 |
| % m/m feedstock | | | | | | |
| Unconverted (370 °C+), | 13.3 | 13.3 | 13.3 | 13.3 | 13.3 | 13.3 |
| % m/m feedstock | | | | | | |
| Product quality | | | | | | |
| Kerosene crystal disappearance point | −43 | −35 | −48 | −42 | −47 | −39 |
| (150-280 °C), °C | | | | | | |
| Gas oil cloud point (280-370 °C), °C | 6 | 11 | −3 | 1 | −2 | 3 |

In example 9 in accordance with the invention, using the sequence of a catalyst comprising a zeolite USY and a zeolite beta followed by a catalyst comprising a zeolite beta having an SAR=250, it was possible to obtain an improvement in the cold properties of the kerosene and diesel cuts (reduction in the crystal disappearance point of the kerosene cut and in the cloud point of the gas oil cut of 5 and 9 °C respectively) and also an improvement in the kerosene yield (+0.1%) compared to example 7 using just one hydrocracking catalyst comprising zeolites USY and beta over the entire catalytic zone.

In example 10 in accordance with the invention, using the sequence of a catalyst comprising a zeolite USY alone followed by a catalyst comprising a zeolite beta having an SAR=250, it was possible to obtain an improvement in the cold properties of the kerosene and diesel cuts (reduction in the crystal disappearance point of the kerosene cut and in the cloud point of the gas oil cut of 7 and 10 °C respectively) and also an improvement in the kerosene yield (+0.2%) compared to example 8 using just one hydrocracking catalyst USY over the entire catalytic zone.

In example 11 (in accordance with the invention), the sequence of a supported hydrocracking catalyst comprising a mixture of zeolites USY and beta followed by the supported catalyst comprising zeolite beta with an SAR of equal to 24 (according to the invention) makes it possible to simultaneously obtain an improvement in the cold properties of diesel and kerosene (reduction in the crystal disappearance point of the kerosene cut and in the cloud point of the gas oil cut of 4 and 8 °C respectively in example 11 according to the invention) and maximize the yield of kerosene (+1.3%) compared to example 7.

In example 12 (in accordance with the invention), the sequence of a supported hydrocracking catalyst comprising a zeolite USY alone followed by the catalyst supported on zeolite beta having an Si/Al ratio of 24 makes it possible to improve the kerosene yields (+0.6%) compared to example 8. Likewise, the cold properties of kerosene and diesel are also improved compared to example 8 (reduction in the crystal disappearance point of the kerosene cut and in the cloud point of the gas oil cut of 4 and 8 °C respectively), showing that the invention also works with a first catalyst consisting solely of USY, without beta.

1. A process for producing middle distillates from at least one fossil hydrocarbon feedstock of which at least 50% by weight of the compounds have an initial boiling point of greater than 250 °C and a final boiling point of less than 800 °C, said fossil hydrocarbon feedstock being co-treated as a mixture with at least one renewable feedstock chosen from vegetable oils, algal oils, cooking oils and animal fats, which may be fresh or spent, alone or as a mixture, and feedstocks obtained from the reprocessing of biomass/plastics/tires/and household waste, alone or as mixtures, said process comprising a step of hydrotreating said feedstock mixture in the presence of hydrogen and of at least one hydrotreatment catalyst and a step of hydrocracking at least some of the hydrotreated feedstock, the hydrocracking step being carried out at a temperature of between 200 °C and 480 °C, at a total pressure of between 1 MPa and 25 MPa with a ratio of volume of hydrogen to volume of hydrocarbon feedstock of between 80 and 5000 liters per liter and at an hourly space velocity (HSV), defined by the ratio of the flow rate by volume of liquid hydrocarbon feedstock to the volume of catalyst charged into the reactor, of between 0.1 and 50 h⁻¹, the step of hydrocracking the hydrotreated feedstock comprising at least:
a) a step of contacting at least some of said hydrotreated feedstock in a first catalytic zone with at least one first catalyst comprising at least one metal from group VIB and/or at least one metal from group VIII of the periodic table and a support comprising at least one zeolite having at least one series of channels the opening of which is defined by a ring of 12 oxygen atoms (12MR), and at least one binder,
b) followed by contacting, in a second catalytic zone, all of the effluent resulting from step a), without an intermediate separation step between said first catalytic zone and said second catalytic zone, with a second catalyst comprising at least one metal from group VIB and/or at least one metal from group VIII of the periodic table and a support comprising at least one zeolite of BEA structure code and at least one binder.

2. The process as claimed in claim 1, wherein the hydrocarbon feedstock is chosen from light gas oils resulting from a catalytic cracking unit, atmospheric distillates, vacuum distillates resulting from the direct distillation of crude oil or from conversion units, such as FCC, coking, H-Oil or visbreaking units, feedstocks originating from units for the extraction of aromatics from lubricating oil bases or resulting from the solvent dewaxing of lubricating oil bases, distillates originating from processes for the fixed-bed or ebullated-bed desulfurization or hydroconversion of ATRs (atmospheric residues) and/or VRs (vacuum residues) and/or deasphalted oils.

3. The process as claimed in claim 1, wherein the vegetable oils are crude or wholly or partially refined and are obtained from the following plants: rapeseed, sunflower, soybean, palm, palm kernel, olive, coconut, jatropha, and the animal fats are chosen from lard or fats composed of residues from the food industry or resulting from the catering industries.

4. The process as claimed in claim 1, wherein the zeolite used in the support of the first catalyst is chosen from zeolites of FAU, BEA, ISV, IWR, IWW, MEI and UWY structural type, taken alone or as a mixture.

5. The process as claimed in claim 4, wherein the zeolite used in the support of the first catalyst is chosen from zeolite Y and zeolite beta, taken alone or as a mixture.

6. The process as claimed in claim 5, wherein the zeolite Y used in the support of the first catalyst has an initial lattice parameter a0 of the unit cell of less than 24.55 Å.

7. The process as claimed in claim 1, wherein the zeolite of BEA structure code used in the support of the second catalyst is a zeolite beta.

8. The process as claimed in claim 7, wherein the second catalyst used in step b) may contain at least one other zeolite chosen from zeolites having at least one series of channels the opening of which is defined by a ring of 12 oxygen atoms (12MR).

9. The process as claimed in claim 1, wherein the volume fraction of the first catalyst used in step a) of the hydrocracking step relative to the whole of the two catalysts used in steps a) and b) is between 50% and 95% by volume.

10. The process as claimed in claim 1, wherein the volume fraction of the second catalyst used in step b) relative to the whole of the two catalysts used in steps a) and b) is between 5% and 50% by volume.

11. The process as claimed in claim 1, wherein the effluent resulting from step b) of the hydrocracking step is sent into a fractionating column in order to recover at least a middle distillates cut and at least a heavy cut comprising unconverted compounds, and said heavy cut is sent either into a second step of hydrocracking in the presence of hydrogen and of a hydrocracking catalyst or into hydrotreatment step a).

12. The process as claimed in claim 4, wherein the zeolite used in the support of the first catalyst is chosen from zeolites of FAU and BEA structural type, taken alone or as a mixture.

13. The process as claimed in claim 4, wherein the zeolite used in the support of the first catalyst is zeolite Y and very preferably dealuminated zeolite USY.

14. The process as claimed in claim 4, wherein the zeolite used in the support of the first catalyst is dealuminated zeolite USY.

15. The process as claimed in claim 5, wherein the zeolite Y used in the support of the first catalyst has an initial lattice parameter a0 of the unit cell of less than 24.45 Å.

16. The process as claimed in claim 5, wherein the zeolite Y used in the support of the first catalyst has an initial lattice parameter a0 of the unit cell of less than 24.40 Å.

17. The process as claimed in claim 1, wherein the zeolite of BEA structure code used in the support of the second catalyst is a zeolite beta having an SiO2/Al2O3 molar ratio or SAR of between 10 and 300.

18. The process as claimed in claim 7, wherein the second catalyst used in step b) contains at least one other zeolite chosen from zeolites of FAU, BEA, ISV, IWR, IWW, MEI, UWY, MFI and MTW structural type or zeolite IZM-2, taken alone or as a mixture.

19. The process as claimed in claim 1, wherein the volume fraction of the first catalyst used in step a) of the hydrocracking step relative to the whole of the two catalysts used in steps a) and b) is between 60% and 95% by volume.

20. The process as claimed in claim 1, wherein the volume fraction of the second catalyst used in step b) relative to the whole of the two catalysts used in steps a) and b) is between 5% and 40% by volume.
